(19) United States
(12) Patent Application Publication
(10) Pub. No.: US 2016/0203194 A1
(43) Pub. Date: Jul. 14, 2016

(54) USER TERMINAL FOR DISPLAYING IMAGE AND IMAGE DISPLAY METHOD THEREOF

(71) Applicant: SAMSUNG ELECTRONICS CO., LTD., Suwon-si (KR)

(72) Inventors: Sae-Hie PARK, Seongnam-si (KR); Chun-Seok LEE, Seoul (KR)

(21) Appl. No.: 14/966,385

(22) Filed: Dec. 11, 2015

(30) Foreign Application Priority Data
Jan. 9, 2015 (KR) 10-2015-0003318

(51) Int. Cl. G06F 17/30; G06T 11/60; G06F 3/0484; G06F 3/0482; G06F 3/0488; G06T 11/20

(52) U.S. Cl. CPC G06F 17/30554; G06F 3/04883; G06T 11/20; G06F 3/04845; G06F 3/04842; G06F 3/0482; G06T 11/60; G06F 17/30864

(57) ABSTRACT

Provided are a user terminal and a method of displaying an image by a user terminal. The method includes: in response to the first input information received in connection with a sketch drawn by a user, acquiring and displaying an image equal or similar to the sketch as a first search result; in response to second input information for editing the image acquired as the first search result, editing and displaying the acquired image; and acquiring and displaying an image equal or similar to the edited image as a second search result.

### CROSS-REFERENCE TO RELATED APPLICATION

This application is based on and claims priority under 35 U.S.C. §119 to Korean Application Serial No. 10-2015-0003318, which was filed in the Korean Intellectual Property Office on Jan. 9, 2015, the disclosure of which is incorporated by reference herein in its entirety.

### TECHNICAL FIELD

The disclosure relates to a user terminal for displaying an image and an image display method thereof and, for example, to a method of searching for an image using a sketch drawn by a user.

### BACKGROUND

As functions which can be provided by a user terminal are diversified, a user may perform functions such as reproducing a video file, photographing a picture or a video, and playing a game through the user terminal. Further, the user may receive a search service by accessing a web server through the user terminal. For example, when the user inputs a search word and a search condition, the web server may provide the user with a search result that matches the search word and the search condition by using a search engine.

The search engine corresponds to software that easily searches for information which the user desires on the Internet, and types of the search engine may include, for example, a word-oriented search engine, subject-oriented search engine, a meta-search engine, and the like.

The search result found through the search engine according to the search word and the search condition input by the user may be provided in the form of text or an image.

In this case, in order to acquire a search result which the user desires, the accuracy of the search word and the search condition, which are input by the user, is required.

When a user uses a search service, the user may not remember a search word to get a search result. Particularly, when the user searches for an image as the search result, the user may feel difficulty in finding a search word related to the image.

Since every user has different feelings and remembers a different search word even for the same image, it is not easy for the user to find an accurate search word.

### SUMMARY

An aspect of the disclosure is to provide a method of searching for an image by using a sketch drawn by the user and, for example, quickly and easily finding a search result, which the user desires, by inputting the drawn sketch and additional information together.

In accordance with an example of the disclosure, a method of displaying an image by a user terminal is provided. The method includes: receiving first input information based on a sketch drawn by a user; in response to the first input information, acquiring and displaying an image that is the same or similar to the sketch as a first search result; receiving second input information for editing a found image based on the first search result; editing and displaying the found image in response to the second input information; and acquiring and displaying an image that is the same or similar to the edited image as a second search result.

The editing and displaying of the found image may include applying attribute information to at least a part of the found image and displaying the image.

The editing and displaying of the found image may include changing at least a part of an outline of the found image and displaying the image.

The displaying of the image that is the same or similar to the sketch may include highlighting an outline of the image that is the same or similar to the sketch and displaying the image.

The method may further include, before the receiving of the first input information, displaying an image used as an underdrawing or a foundation of the sketch.

The method may further include, when a plurality of images are displayed as the first search result, receiving third input information for selecting at least one image to be edited, from the plurality of images.

The attribute information may be at least one of emotional information, scent information, material information, color information, touch information, sound information, weather information, temperature information, and atmosphere information.

The acquiring and displaying of the image that is the same or similar to the edited image as the second search result may include acquiring the image that is the same or similar to the edited image from an external server connected to the user terminal and displaying the acquired image the second search result.

In accordance with another example of the disclosure, a method of providing an image by a server is provided. The method includes: acquiring information related to a sketch from a user terminal; acquiring an image that is the same or similar to the sketch as a first search result based on the information related to the sketch; transmitting the image corresponding to the first search result to the user terminal; acquiring edited information of the image from the user terminal; acquiring an image that is the same or similar to the edited image as a second search result based on the edited information; and transmitting the image corresponding to the second search result to the user terminal.

The acquiring of the edited information of the image may include acquiring attribute information related to the image.

In accordance with another example of the disclosure, a user terminal for displaying an image is provided. The user terminal includes: input circuitry configured to receive an input; a display configured to display an image; a memory configured to store one or more programs; and a processor configured, for example, by executing instructions included in the one or more programs of the memory, to acquire, in response to first input information related to a sketch drawn by a user through the input circuitry, an image that is the same or similar to the sketch as a first search result and to display the acquired image on the display, to edit a found image based on the first search result in response to second input information for editing the found image and to display the edited image, and to acquire and display an image that is the same or similar to the edited image as a second search result.

When the found image is edited and displayed on the display, the processor may be configured, for example, by executing instructions, to apply attribute information to at least a part of the found image and to display the image.

When the found image is edited and displayed on the display, the processor may be configured, for example, by executing instructions, to change at least a part of an outline of the found image and to display the image.

When the image that is the same or similar to the sketch is displayed on the display, the processor may be configured, for example, by executing instructions, to highlight an outline of the image that is the same or similar to the sketch and to display the image.

The processor may be configured, for example, by executing instructions, to display an image used as an underdrawing or a foundation of the sketch.

The attribute information may be at least one of emotional information, weather information, temperature information, scent information, material information, color information, touch information, sound information, and atmosphere information.

When the image that is the same or similar to the edited image is acquired as the second search result and displayed on the display, the processor may be configured, for example by executing instructions, to acquire the image that is the same or similar to the edited image from an external server connected to the user terminal and to display the acquired image as the second search result.

In accordance with another example of the disclosure, a server for providing an image is provided. The server includes: communication circuitry configured to communicate with a user terminal; a memory configured to store one or more programs; and a processor configured, for example, by executing instructions stored in one or more programs of the memory, to acquire, based on information related to a sketch acquired from the user terminal through the communication circuitry, an image that is the same or similar to the sketch as a first search result and to transmit the acquired image to the user terminal, to acquire, based on edited information of the image acquired from the user terminal, an image that is the same or similar to the edited image as a second search result, and to transmit the acquired image to the user terminal.

The processor may be configured, for example by executing instructions, to transmit the image that is the same or similar to the edited image to the user terminal based on attribute information related to the image acquired from the user terminal.

According to various examples of the disclosure as described above, the user may quickly search for a desired image through a drawing of a sketch and an editing process thereof.

Further, an underdrawing, a foundation, or an additional search result that helps the sketch of the user is provided during a process in which the user draws the sketch, thereby increasing the user convenience to perform the sketch.

In addition, other effects obtained or expected by examples of the disclosure will be directly or implicitly disclosed in the following detailed description. For example, various effects expected according to examples of the disclosure will be disclosed in the following detailed description.

### BRIEF DESCRIPTION OF THE DRAWINGS

The above and other aspects, features, and advantages of the disclosure will be more apparent from the following detailed description taken in conjunction with the accompanying drawings, in which like reference numerals refer to like elements, and wherein:

FIG. 1 is a block diagram illustrating an example configuration of an example system;

FIG. 2 is a block diagram illustrating an example configuration of an example user terminal;

FIG. 3 is a diagram illustrating an example structure of software stored in the user terminal;

FIG. 4 is a block diagram illustrating an example configuration of an example server;

FIG. 5 is a flowchart illustrating an example process in which the server constructs a database;

FIG. 6 is a flowchart illustrating an example process in which the server searches for and acquires an image, which the user desires;

FIGS. 7A to 7C are diagrams illustrating an example process in which the user terminal displays a found image;

FIGS. 8A and 8B are diagrams illustrating an example process in which the user terminal displays a found image;

FIGS. 9A to 9C are diagrams illustrating an example process in which the user terminal displays a found image;

FIGS. 10A to 10C are diagrams illustrating an example process in which the user terminal displays a found image;

FIGS. 11A to 11C are diagrams illustrating example attribute information related to at least a part of an image;

FIGS. 12A and 12B are diagrams illustrating example drawn sketches;

FIG. 13 is a diagram illustrating an example found image;

FIGS. 14 and 15 are flowcharts illustrating an example method in which the user terminal displays an image; and

FIG. 16 is a block diagram illustrating an example configuration of the user terminal.

### DETAILED DESCRIPTION

The terms used in the disclosure will be briefly described and the disclosure will be described in greater detail below.

For the terms used in examples of the disclosure, general terms, which are used as widely as possible in consideration of functions in the disclosure, are selected, but the terms may vary depending on an intention of those skilled in the art, a precedent, appearance of a new technology, and the like. In addition, a term arbitrarily selected by the applicant may be used. For example, the meaning of the term will be described at the corresponding part in the disclosure. Thus, a term used herein should be defined based on the meaning of the term and the contents of the disclosure rather than merely on the name expressed by the term.

The disclosure may be variously modified or changed and may have various examples, and thus specific examples embodiments will be described in greater detail with reference to the accompanying drawings. However, it should be understood that there is no intent to limit the disclosure to the particular forms disclosed, but on the contrary, the disclosure is intended to cover all modifications, equivalents, and alternatives falling within the spirit and scope of the disclosure. Further, in the following description of the disclosure, a detailed description of known technologies incorporated herein will be omitted when it may make the subject matter of the disclosure unclear.

Although the terms “ordinal numbers” such as first, second and the like are used to describe various structural elements, the structural elements should not be defined by the terms. The terms are used merely for the purpose to distinguish an element from the other elements.

As used herein, the singular forms are intended to include the plural forms as well, unless the context clearly indicates otherwise. In the disclosure, it should be understood that the terms “include” or “have” indicate existence of a feature, a number, a step, an operation, a structural element, parts, or a combination thereof, and do not exclude the existences or probability of addition of one or more another features, numeral, steps, operations, structural elements, parts, or combinations thereof.

In examples of the disclosure, the term “module” or “unit” may perform at least one function or operation, and may be implemented by hardware (e.g., circuitry), software, or a combination of hardware and software. Further, a plurality of “modules” or “units” may be integrated into at least one module and be implemented as at least one processor (not shown), except for “modules” or “units” that need to be implemented by specific hardware.

In examples of the disclosure, when it is described that an element is “connected” to another element, not only the first element may be “connected directly” to the second element, but the first element may also be “electrically connected” to the second element while a third element is interposed therebetween. Further, when it is described that a certain unit “includes” a certain element, this means that the unit may include any other element rather than exclude other elements unless otherwise indicated.

Examples of the disclosure will be described in more detail with reference to the accompanying drawings. However, the disclosure may be implemented in various different forms and is not limited to examples described herein. Further, parts irrelevant to the disclosure are omitted in the drawings to make the disclosure clear and the same reference numerals are designated to the same or similar components throughout the disclosure.

Further, according to an example of the disclosure, a user input may, for example, include at least one of a touch input, a bending input, a voice input, a button input, and a multimodal input, but the present disclosure is not limited thereto.

According to an example of the disclosure, the “touch input” refers to an input conducted on a display and/or a cover to control a device. Further, the “touch input” may include a touch (for example, floating or hovering) which is separated from the display by a predetermined distance or more without any contact. The touch input may include a touch & hold gesture, a tap gesture of touching and then releasing the touch, a double tap gesture, a panning gesture, a flick gesture, a touch drag gesture of touching and then moving in one direction, a pinch gesture, and the like, but the present disclosure is not limited thereto.

According to an example of the disclosure, the “button input” refers to an input through which a device is controlled by using a physical button attached to the device.

According to an example of the disclosure, the “motion input” refers to a motion which may be applied to the device to control the device. For example, the motion input may include an input of rotating the device, tilting the device, or moving the device in an up, down, left, or right direction.

According to an example, the “multimodal input” refers to a combination of two or more input types. For example, the device may receive the touch input and the motion input, or receive the touch input and the voice input of the user, etc.

Further, according to an example of the disclosure, an “application” may refer to a set or a series of computer programs designed to perform a particular task. According to an example of the disclosure, there may be various applications. For example, the applications may include a game application, a video reproduction application, a map application, a memo application, a calendar application, a phone book application, a broadcasting application, an exercise supporting application, a payment application, a picture folder application, and the like, but the disclosure is not limited thereto.

Further, according to an example of the disclosure, “application identification information” may, for example, be unique information for distinguishing the application from other applications. For example, as the application identification information, an icon, an index item, link information, and the like may be provided, but the disclosure is not limited thereto.

According to an example of the disclosure, a User Interface (UI) element refers to an element which can perform an interaction with the user and transmit a visual, auditory, or olfactory feedback based on, for example, a user input. The UI element may be expressed in the form of at least one of an image, text, and a dynamic image. If there is an area in which the above described information is not displayed but a feedback is possible based on a user input, the area may be referred to as the UI element. Further, the UI element may be the aforementioned application identification information.

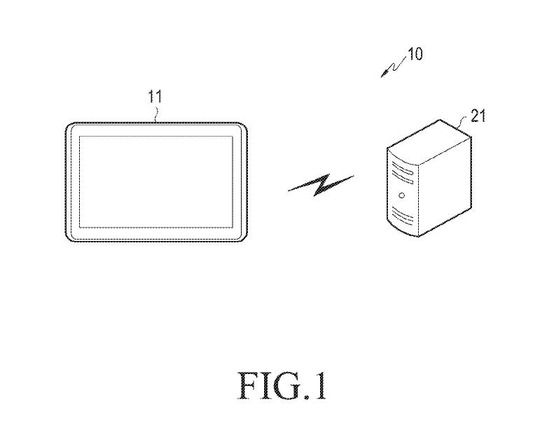

FIG. 1 is a block diagram illustrating an example configuration of an example system 10.

Referring to FIG. 1, the system 10 may provide a user terminal 11 and a search server 21. The user terminal 11 and the search server 21 may be connected to each other through various communication schemes. For example, the user terminal 11 and the search server 21 may communicate with each other by using various long distance wireless communication modules such as 3rd Generation (3G), 3rd Generation Partnership Project (3GPP), Long Term Evolution (LTE), and the like.

In FIG. 1, when the user terminal 11 receives input information related to a drawn sketch, the user terminal 11 may transfer information related to the drawn sketch to the search server 21. In response to the received information, the search server 21 may acquire an image based on the drawn sketch and transmit the acquired image to the user terminal 11.

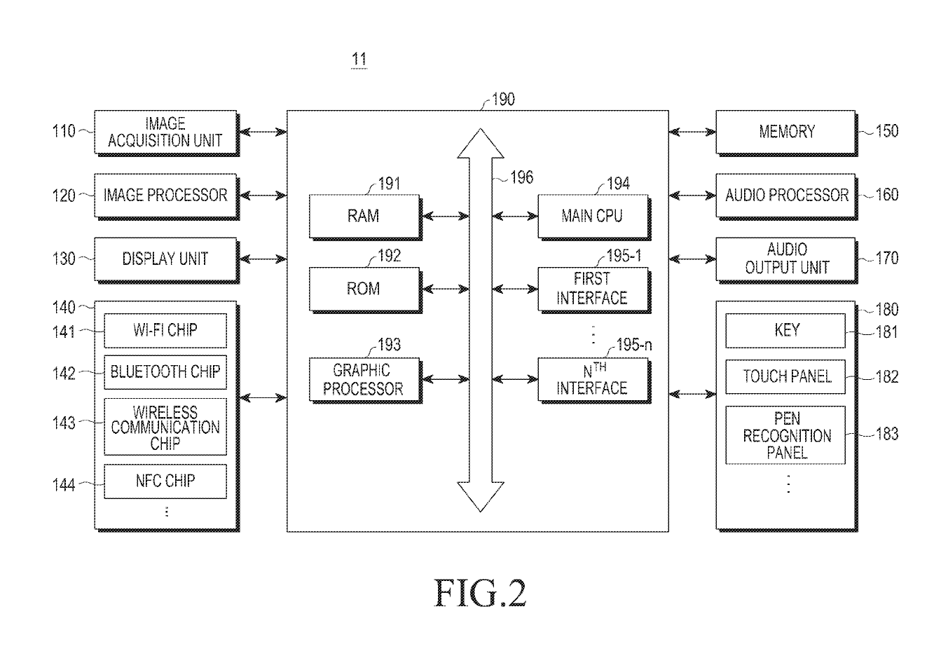

FIG. 2 is a block diagram illustrating an example configuration of the example user terminal (for example, the user terminal 11).

The configuration of the user terminal 11 illustrated in FIG. 2 may be applied to various types of mobile device such as wearable devices, for example, a smart phone, tablet, notebook, PDA, electronic frame, desktop PC, digital TV, camera, wrist watch, or Head-Mounted Display (HMD), or the like.

As illustrated in FIG. 2, the user terminal 11 may include at least one of an image acquisition unit (e.g., including circuitry) 110, an image processor 120, a display unit (e.g., including a display) 130, a communication unit (e.g., including communication circuitry) 140, a memory 150, an audio processor 160, an audio output unit 170, an input unit (e.g., including input circuitry) 180, and a processor 190. The configuration of the user terminal 11 illustrated in FIG. 2 is only an example and not necessarily limited to the aforementioned block diagram. Some of the configuration of the user terminal 11 illustrated in FIG. 2 may be modified or added based on the type of the user terminal 11 or the purpose of the user terminal 11.

The image acquisition unit 110 may, for example, acquire image data through various sources. For example, the image acquisition unit 110 may receive image data from an external server or an external device.

The image acquisition unit 110 may photograph an external environment to acquire image data. For example, the image acquisition unit 110 may be implemented by a camera that photographs the external environment. For example, the image acquisition unit 110 may include a lens (not shown) that allows an image to pass therethrough and an image sensor (not shown) that detects the image having passed through the lens. The image sensor (image) may, for example, be implemented by a CCD image sensor or a CMOS image sensor. The image data acquired through the image acquisition unit 110 may be processed by the image processor 120.

The image processor 120 may refer to a component for processing the image data received by the image acquisition unit 110. The image processor 120 may perform various image processing such as a decoding, scaling, noise-filtering, frame rate conversion, resolution conversion, of the image data, or the like.

The display unit 130 may be configured to display a video frame processed by the image processor 120 or at least one of the various screens generated by a graphic processor 193.

An implementation method of the display unit 130 (e.g., including a display) is not limited, and may be implemented as various types of display, for example, a Liquid Crystal Display (LCD), an Organic Light Emitting Diode (OLED) display, an Active-Matrix Organic Light-Emitting Diode (AM-OLED), a Plasma Display Panel (PDP), and the like. The display unit 130 may further include an additional configuration based on the implementation method thereof. For example, when the display unit 130 is a liquid crystal type, the display unit 130 may include an LCD display panel (not shown), a backlight unit (not shown) that supplies a light to the LDC display panel, and a panel driving substrate (not shown) that drives a panel (not shown). The display unit 130 may be provided as a touch screen (not shown) while being coupled to a touch panel 182 of the user input unit 180.

The display unit 130 may be coupled to at least one of the front area, side area, and rear area of the user terminal 11 in the form of a bended display. The bended display may be implemented by a flexible display or a normal display which is not flexible. For example, the bended display may be implemented by connecting a plurality of flat displays.

When the bended display is implemented by the flexible display, the ability to be bent, twisted or rolled up without any damage through, for example, a thin and flexible substrate may be features of the flexible display. The flexible display may be produced with a plastic substrate as well as a glass substrate which has been generally used. When the plastic substrate is used, the substrate may be formed through a low temperature production process without the conventional production process in order to prevent and/or reduce the damage of the substrate. Further, the flexible display may have flexibility to be folded and unfolded by replacing the glass substrate that surrounds a liquid crystal in the LCD, OLED display, AM-OLED, PDP, and the like with the plastic film. The flexible display is thin, light, shock-resistant, twistable, and bendable, so that the flexible display can be manufactured in various forms.

The communication unit (e.g., including communication circuitry) 140 is a component that communicates with various types of external device according to various types of communication scheme. The communication unit 140 may include at least one of a Wi-Fi chip 141, a Bluetooth chip 142, a wireless communication chip 143 and a Near Field Communication (NFC) chip 144. The processor 190 may communicate with an external server or various external devices by using the communication unit 140.

For example, the Wi-Fi chip 141 and the Bluetooth chip 142 may communicate through a Wi-Fi scheme and a Bluetooth scheme, respectively. When the Wi-Fi chip 141 or the Bluetooth chip 142 is used, various pieces of connection information such as SubSystem IDentification (SSID), a session key, and the like are first transmitted and received and, after communication connection is performed using the transmitted and received connection information, various pieces of information may be transmitted and received. The wireless communication chip 143 may refer to a chip that performs communication according to various communication standards such as Institute of Electrical and Electronics Engineers (IEEE) communication standards, Zigbee, 3rd Generation (3G), 3rd Generation Partnership Project (3GPP), Long Term Evolution (LTE), and the like. The NFC chip 144 may refer to a chip which operates by an NFC scheme using a bandwidth of 13.56 MHz among various Radio Frequency IDentification (RF-ID) frequency bandwidth of 135 kHz, 13.56 MHz, 433 MHz, 860˜960 MHz, 2.45 GHz, and the like.

The memory 150 may store various programs and data required for the operation of the user terminal 11. The memory 150 may be implemented by a non-volatile memory, a volatile memory, a flash-memory, or a Hard Disk Drive (HDD) or a Solid State Drive (SSD). The memory 150 may be accessed by the processor 190 and perform tape-recording/recording/editing/deleting/updating of data by the processor 190. According to the disclosure, the term “memory” may include a Read Only Memory (ROM) (not shown) and a Random Access Memory (RAM) (not shown) within the processor 190, or a memory card (not shown) (for example, a micro SD card or a memory stick) installed in the user terminal 11. For example, the memory 150 may store a program and data for configuring various screens to be displayed in a display area.

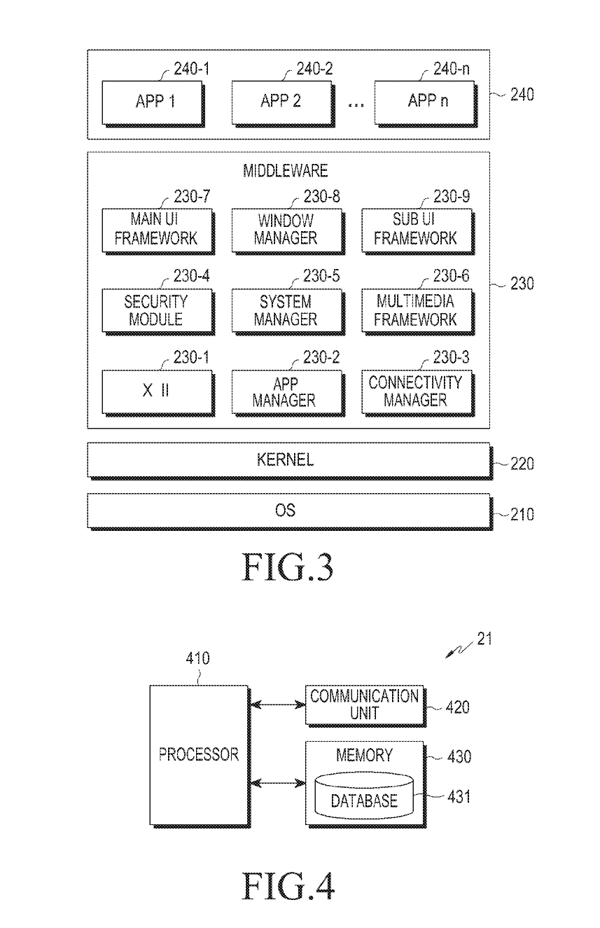

A structure of software stored in the user terminal 11 will be described with reference to FIG. 3. Referring to FIG. 3, the memory 150 may store software including an Operating System (OS) 210, a kernel 220, middleware 230, applications 240, and the like.

The OS 210 performs a function of controlling and managing the general operation of hardware. For example, the OS 210 corresponds to a layer that serves a general function such as hardware management, memory, security, and the like.

The kernel 220 serves as a passage that transfers various signals including a touch signal and the like received by the user input unit 180 to the middleware 230.

The middleware 230 includes various software modules that control the operation of the user terminal 11. Referring to FIG. 3, the middleware 230 may, for example, include an X11 module 230-1, an APP manager 230-2, a connectivity manager 230-3, a security module 230-4, a system manager 230-5, a multimedia framework 230-6, a main UI framework 230-7, a window manager 230-8, and a sub UI framework 230-9.

The X11 module 230-1 may refer to a module that receives various event signals from various hardware included in the user terminal 11. The event may be variously configured, such as an event in which a user gesture is detected, an event in which a system alarm is generated, an event in which a particular program is executed or terminated, and the like.

The APP manager 230-2 may refer to a module that manages an execution state of various applications 240 installed in the memory 150. When an application execution event is detected by the X11 module 230-1, the APP manager 230-2 may call and execute an application corresponding to the corresponding event.

The connectivity manager 230-3 may refer to a module that supports a wired or wireless network connection. The connectivity manager 230-3 may include various sub modules such as a DNET module, a UPnP module, and the like.

The security module 230-4 may refer to a module that supports certification of hardware, permission, secure storage, and the like.

The system manager 230-5 monitors states of the components within the user terminal 11 and provides a monitoring result to other modules. When a residual quantity of a battery is not sufficient, an error occurs, or a communication connection is disconnected, the system manager 230-5 may provide the monitoring result to the main UI framework 230-7 or the sub UI framework 230-9 to output a notification message and/or a notification sound.

The multimedia framework 230-6 may refer to a module that reproduces multimedia contents stored in the user terminal 11 or provided from an external source. The multimedia framework 230-6 may include a player module, a camcorder module, a sound processing module, and the like. Accordingly, the multimedia framework 230-6 may perform an operation of reproducing various types of multimedia contents and generating and reproducing a screen and sound.

The main UI framework 230-7 may refer to a module that provides various UIs to be displayed in a main area of the display unit 130, and the sub UI framework 230-9 may refer to a module that provides various UIs to be displayed in a sub area of the display unit 130. The main UI framework 230-7 and the sub UI framework 230-9 may include an image compositor module for configuring various UI elements, a coordinate compositor module for calculating a coordinate to display the UI element, a rendering module for rendering the configured UI element on the calculated coordinate, and a 2D/3D UI toolkit for providing a tool for configuring a 2D or 3D form UI.

The window manager 230-8 may detect a touch event using a user's body or a pen or other input events. When the event is detected, the window manager 230-8 may transfer an event signal to the main UI framework 230-7 or the sub UI framework 230-9 to perform an operation corresponding to the event.

The application module 240 includes applications APP#1 240-1, APP#2 240-2, . . . , APP#n 240-n to support various functions. For example, the application module 240 may include a program module for providing various services such as a navigation program module, a game module, an electronic book module, a calendar module, an alarm management module, and the like. The applications may be installed by default or may be randomly installed and used by the user during a utilization process. When the UI element is selected, a main CPU 194 may execute an application corresponding to the selected UI element by using the application module 240.

The structure of the software illustrated in FIG. 3 is only an example, and the disclosure is not necessarily limited thereto. Accordingly, some of the components may be omitted, changed, or added based on the type of the user terminal 11 or the purpose of the user terminal 11.

Referring back to FIG. 2, the audio processor 160 may refer to a component that processes audio data of image contents. The audio processor 160 may perform various processing such as a decoding, amplifying, noise-filtering, and the like of the audio data. The audio data processed by the audio processor 160 may be output to the audio output unit 170.

The audio output unit 170 may refer to a component that outputs various notification sounds and a voice message as well as various pieces of audio data which have passed through various processing tasks such as the decoding, amplifying, and noise filtering by the audio processor 160. For example, the audio processor 170 may be implemented by a speaker but it is only an example, and may be implemented by an output terminal which may output audio data.

The user input unit 180 may receive various instructions from the user. The user input unit 180 may include at least one of a key 181, a touch panel 182, and a pen recognition panel 183.

The key 181 may include various types of keys such as a mechanical button, a wheel, and the like, which are formed on various areas such as a front surface, a side surface, a rear surface, and the like of an appearance of a main body of the user terminal 11.

The touch panel 182 may detect a touch input, and may output a touch event value corresponding to the detected touch signal. When a touch screen (not shown) is configured by a combination of the touch panel 182 and the display unit 130, the touch screen may include various types of touch sensors such as a capacitive type, resistive type, piezoelectric type, and the like. The capacitive type corresponds to a scheme of determining touch coordinates by detecting minute electric energy caused by a body of a user when a part of the body of the user touches a surface of the touch screen by using a dielectric coated on the surface of the touch screen. The resistive type corresponds to a scheme of determining touch coordinates by detecting that upper and lower plates at touched points are in contact with each other so that a current flows when a user touches a screen, while including two electrode plates embedded in the touch screen. A touch event generated on the touch screen may be mainly generated by a user's finger, but may be generated by an object of conductive material which can make a change in capacitance.

The pen recognition panel 183 may detect a proximity input or a touch input of a pen based on an operation of a touch pen (for example, a stylus pen and a digitizer pen), and may output the detected pen proximity event or the pen touch event. The pen recognition panel 183 may be implemented through an ElectroMagnetic Resonance (EMR) scheme, and may detect a touch or a proximity input according to a proximity of a pen or an intensity change in an electromagnetic field by a touch. For example, the pen recognition panel 183 may include an electromagnetic induction coil sensor (not shown) having a grid structure and an electromagnetic signal processing unit (not shown) for sequentially providing an alternating signal having a predetermined frequency to each loop coil of the electromagnetic induction coil sensor. When a pen in which a resonant circuit is embedded is located in the vicinity of the loop coils of such a pen recognition panel 183, a magnetic field transmitted from the corresponding loop coil generates a current based on mutual electromagnetic induction of the resonant circuits within the pen. Based on the current, the induced magnetic field is generated from the coil constituting the resonant circuit within the pen, and the pen recognition panel 183 may detect the induced magnetic field from the loop coil in a signal reception state so as to detect a proximity location or a touch location of the pen. The pen recognition panel 183 may have a predetermined area, for example, an area which can cover a display area of the display panel 130 on the lower part of the display unit 130.

The processor 190 may be configured to control the general operation of the user terminal 11, and may perform the control using various programs stored in the memory 150.

The processor 190 may include a RAM 191, a ROM 192, the graphic processor 193, a main CPU 194, first to n^{th} interfaces 195-1 to 195-n, and a bus 196. At this time, the RAM 191, the ROM 192, the graphic processor 193, the main CPU 194, and the first to n^{th} interfaces 195-1 to 195-n may be connected to each other through the bus 196.

The RAM 191 stores an O/S and an application program. For example, when the user terminal 11 is booted, the O/S may be stored in the RAM 191 and various pieces of application data selected by the user may be stored in the RAM 191.

The ROM 192 stores a command set and the like for system booting. When a turn on command is input to supply power, the main CPU 194 copies the O/S stored in the memory 150 into the RAM 191 based on the command stored in the ROM 192 and execute the O/S to boot the system. When the booting is completed, the main CPU 194 performs various operations by copying various application programs stored in the memory 150 to the RAM 191 and executing the application program copied into the RAM 191.

The graphic processor 193 generates a screen including various objects, such as an item, an image, text, and the like, by using a calculation unit (not shown) and a rendering unit (not shown). The calculation unit may be a component that calculates an attribute value such as coordinate values to display objects, shapes, sizes, colors, and the like according to a layout of the screen by using a control command received from the user input unit 180. Further, the rendering unit may be a component that generates screens of various layouts including objects based on the attribute value calculated by the calculation unit. The screen generated by the rendering unit may be displayed within the display area of the display unit 130.

The main CPU 194 accesses the memory 150 to boot the system by using the O/S stored in the memory 150. Further, the main CPU 194 performs various operations by using various programs, contents, data, and the like stored in the memory 150.

The first to n^{th} interfaces 195-1 to 195n are connected to the aforementioned various components. One of the first to n^{th} interfaces 195-1 to 195n may be a network interface connected to an external device through a network.

For example, in response to an input of drawing a sketch, the processor 190 may be configured to control the display unit 130 to display the image found based on the sketch. Further, in response to an input of editing the found sketch, the processor 190 may be configured to control the display unit 130 to display an image found based on the edited image.

FIG. 4 is a block diagram illustrating an example configuration of the server 21.

As illustrated in FIG. 4, the server 21 may include a processor 410 and a communication unit (e.g., including communication circuitry) 420 including, for example, a long distance communication module for communicating with the user terminal 11, and a memory 430. The memory 430 may include a database 431 that stores programs and images required for the operation of the server.

The processor 410 of the server 21 may be configured to construct the database 431 storing the images by executing the program stored in the memory 430. The processor 410 may be configured to acquire an image related to the sketch received from the user terminal 11 from the database 431 by executing the program stored in the memory 430. A function of searching for an image, which the processor 410 desires, may be performed by, for example, a search engine module.

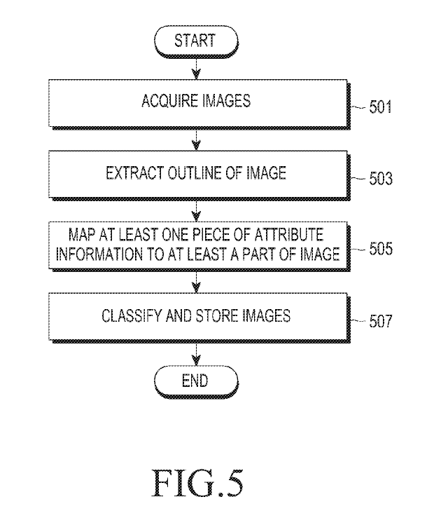

FIG. 5 is a flowchart illustrating an example process of constructing the database 431 by the server 21.

Although FIG. 4 illustrates that the server 21 includes the database 431, the database 431 may be included in another server of a cloud (not shown) if the server 21 is included in the cloud according to another example. Further, a part of the database 431 may be included in a first server and the other part of the database 431 may be included in a second server.

Referring to FIG. 5, the processor 410 may be configured to acquire images in step 501. For example, the processor 410 may be configured to automatically acquire images on the Internet using an image search tool and store the acquired images in the database 431. The processor 410 may be configured to acquire an image, which a person manually registers, and to store the acquired image in the database 431.

The processor 410 may be configured to extract outlines from the acquired images in step 503. For example, the processor 410 may be configured to generate vector information used as a search key using the extracted outlines. The vector information may, for example, be a comparative target to be compared with information related to the sketch drawn by the user. For example, the processor 410 may be configured to compare the vector information and the sketch information to determine a similarity therebetween.

In an example method of generating the vector information, the processor 410 may be configured to convert pixels corresponding to the outline of the acquired image into a black color and to convert pixels, which are not included in the outline, into a white color. For example, a method of determining the outline of the image by the processor 410 may include a method of manually making an input by a person, a method of using an automation algorithm, and a method of using the two methods at the same time.

The method of manually making the input by the person may be a method of making the input by directly drawing the outline cone sponding to the feature of the image by the person. For example, the method may be a method of directly drawing the outline by the person with reference to the image provided by the server 21.

The method of using the automation algorithm may be a method of extracting the outline of the image using, for example, a Canny edge detector. For example, the Canny edge detector may remove noise by applying a Gaussian blur effect to the image and determine an image intensity difference and direction by applying a gradient operator. Next, the Canny edge detector may extract the outline of the image along a part having the largest gradient by applying edge thinning to the image.

Other methods of extracting the outline of the image may be used within a range to be implemented by those skilled in the art, and a detailed description thereof will be omitted in the disclosure.

When the outline of the image is incomplete, the processor 410 may be configured to automatically change a thickness of the outline or to connect separated outlines.

The processor 410 may be configured to map at least one piece of attribute information to at least a part of the image in step 505. The processor 410 may be configured to map at least one piece of attribute information to at least a part of the extracted outline.

In this case, step 505 may be performed before step 503 or steps 505 and 503 may be simultaneously performed.

The processor 410 may be configured to map at least one piece of attribute information to an entirety or a part of the image. The processor 410 may be configured to map at least one piece of attribute information to an entirety or a part of the extracted outline. The attribute information may be at least one of, for example, emotional information, scent information, color information, material information, weather information, temperature information, touch information, sound information, and atmosphere information, but is not limited thereto.

For example, the person may directly map the attribute information to the image or a part of the image, or the processor 410 may be configured to automatically map the attribute information. For example, the processor 410 may be configured to automatically map the attribute information by using tagging information on the image.

The tagging information may, for example, correspond to information generated by a person or a device when the image is generated or after the image is generated. For example, the tagging information may be various pieces of additional information related to the image such as a title of the image, a date when the image is generated, a place where the image is generated, a comment on the image, an evaluation of the image, a generator of the image, a recommender of the image, and information on a device that generates the image, etc.

The processor 410 may be configured to classify the images and to store the classified images in the database 431 in step 507. The processor 410 may be configured to classify the images based on tagging information on the image, attribute information on the image, and a similarity of the image.

The processor 410 may be configured to classify images having similar outlines based on the outline of the image, but may be configured to classify the images based on tagging information on the image and attribute information on the image. Further, the processor 410 may be configured to classify the images based on relevant surrounding information of the image (for example, a position where the image is acquired, a path along which the image is acquired, and the like) when the image is acquired.

In a state where the images are classified in the database 431, the server 21 may acquire information related to the sketch from the user terminal 11. For example, when information related to a shoe-shaped sketch is acquired, the server 21 may acquire images having outlines that are the same as or similar to the sketch from the database 431 as a search result based on the information related to the sketch.

When it is determined that the sketch drawn by the user is the shoe based on the information related to the sketch, the server 21 may acquire images classified as the shoe from the database 431 even though the shape of the sketch may be different.

The processor 410 may be configure to normally use the outline extracted from the image as a search key, but may also be configured to use the attribute information on the image or the tagging information on the image as an additional search key. As described above, through the use of various types of search keys, the accuracy of the search may be improved and the user may receive various search results.

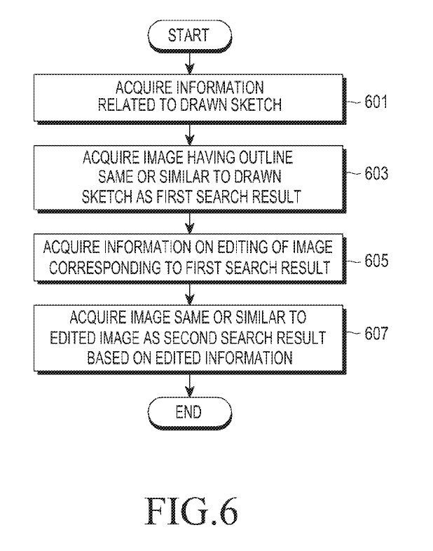

FIG. 6 is a flowchart illustrating an example process in which the server 21 searches for and acquires an image, which the user desires.

Referring to FIG. 6, the server 21 may acquire information related to the sketch drawn by the user from the user terminal 11 in step 601. The information related to the drawn sketch may be, for example, data generated by compressing the drawn data in a particular format.

The server 210 may acquire an image that is the same as or similar to the sketch as a first search result based on the information related to the sketch in step 603.

For example, the server 21 may search for at least one image having the outline similar to the sketch from the database 431 based on the acquired information related to the sketch. A method of measuring the similarity between the drawn sketch and the outline of the image stored in the database 431 by the server 21 may use, for example, a Chamfer matching algorithm, an algorithm using a Hausdorff distance, an algorithm using a Hilbert scan distance, and the like. Other methods of measuring or determining the similarity may be known within a range to be implemented by those skilled in the art, and a detailed description thereof will be omitted in the disclosure.

The server 21 may select images including outlines having high similarity with the sketch from the images stored in the database 431 as a result of the measurement of the similarity, and acquire a predetermined number of images sequentially having higher similarities as a first search result in step 603.

When similarity values between the sketch and the outlines of the images are within a predetermined range, the server 21 may determine the images within the range as the first search result. For example, when the Chamfer matching algorithm is used, a chamfer score for an edge point direction between the sketch and the images may be calculated. At this time, as the similarity between the sketch and the outline of the image is higher, the chamfer score value may have a value closer to “0”. In this case, images having the chamfer scores close to “0” included within the predetermined range may be determined as the first search result.

The image corresponding to the first search result may be an image of which the outline is highlighted, for example, an image only having the outline or an image of which the outline thickness or color is changed. The image corresponding to the first search result may be an image including a surface having a color or an image including both the highlighted color and the colored surface.

The server 21 may acquire information on an editing of the image corresponding to the first search result from the user terminal 11 in step 605. The information on the editing of the image corresponding to the first search result may be, for example, data generated by compressing the edited image in a particular format.

When information on the first search result remains in the server 21, the edited information corresponds to edited information on the image and may be at least one of, for example, edited color information on at least a part of the image, information on a change in the outline of the image (for example, a position of the change, a thickness of the outline, a color of the outline, and the like), and movement information on the image (for example, a movement distance of the image, a moved coordinate of the image, and the like).

The server 21 may acquire attribute information related to at least a part of the edited image. The attribute information may be at least one of, for example, emotional information, scent information, material information, weather information, temperature information, color information, touch information, sound information, and atmosphere information.

The server 21 may acquire an image that is the same as or similar to the edited image as a second search result based on the information related to the edited image in step 607.

For example, the server 21 may acquire images having high similarity with the edited image from the database 431 as a second search result. The server 21 may acquire images including the outline having high similarity with the outline of the edited image from the database 431 as the second search result. The server 21 may acquire images to which particular attribute information is mapped, from the images including the outline having high similarity with the drawn sketch as the second search result.

The server 21 may acquire the image corresponding to the second search result from the images acquired as the first search result or perform the search again in the database 431 to acquire the image.

The processor 410 of the server 21 may be configured to update the database 431 using the search result. The server 21 may update information on the image related to the search result based on information received from the user terminal 11 during a process of drawing the sketch and acquiring the desired search result by the user.

For example, the user may input one or more pieces of attribute information related to the sketch. The server 21 may map the one or more pieces of attribute information to the found image based on the information related to the sketch and store the mapped information in the database 431.

The user may input one or more pieces of attribute information related to the edited image. The server 21 may map the one or more pieces of attribute information to the found image based on the information related to the edited image and store the mapped information in the database 431.

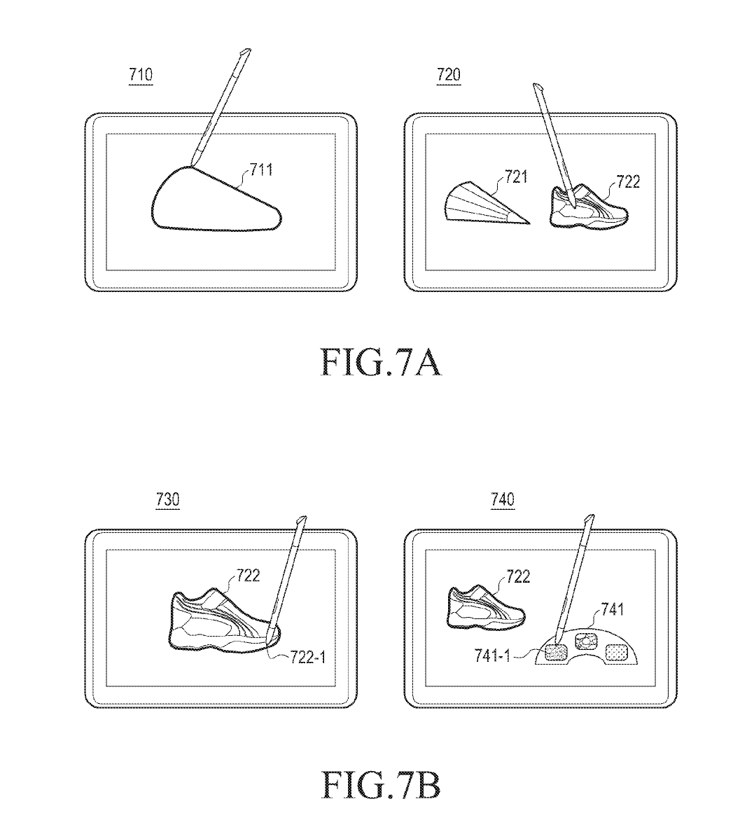

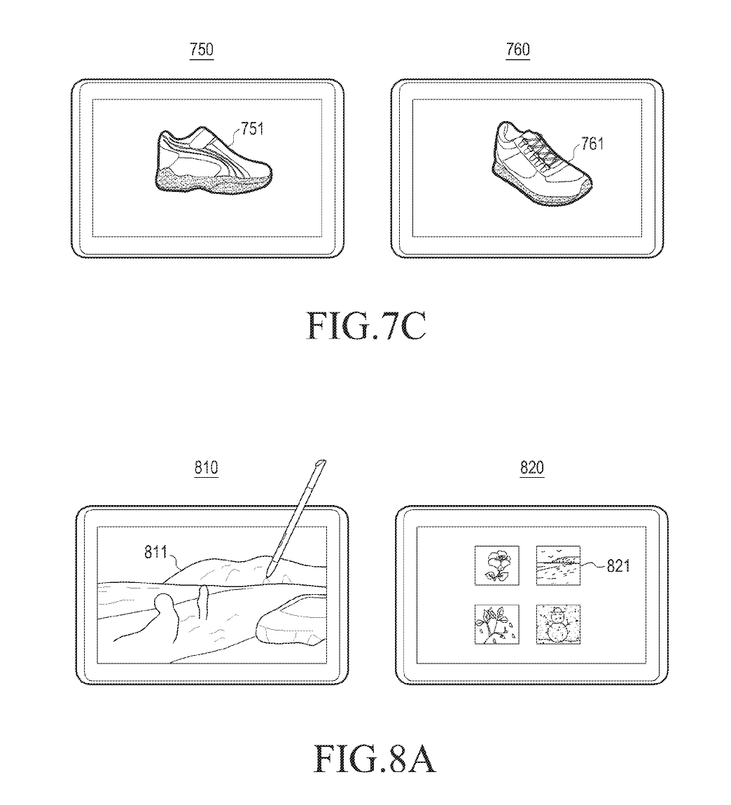

FIGS. 7A to 7C are diagrams illustrating an example process in which the user terminal 11 displays a found image.

Referring to reference numeral 710 of FIG. 7A, the user input unit 180 may receive a user input of drawing a sketch 711 on the display unit 130 using a finger or an input tool (for example, a stylus pen, a mouse, a digitizer, or the like, see, e.g., FIG. 2). The sketch may, for example, be performed through the application of various colors, thicknesses, or effects (for example, pencil effect, brush effect, a marker effect, and the like).

In another example, the user may draw the sketch on a background of the image displayed on the display unit 130. For example, the user may display a desired image as a background on the display unit 130 by photographing a subject or using a text keyword. When the image is displayed, the user may draw the sketch on the displayed image. When the sketch is completed, the user may remove the displayed image and leave only the drawn sketch.

In another example, the user may draw a sketch of the image displayed on the display unit 130 as an underdrawing. For example, the processor 190 may be configured to control the display unit 130 to display only the outline of the displayed image. In such a situation, the user input unit 180 may receive a user input of drawing the sketch on a background of the displayed outline. For example, a user input of drawing the sketch using an underdrawing may be a user input of deleting a part of the underdrawing, extending the part, adding a sketch, increasing or decreasing a size of the underdrawing, changing a position of at least a part of the underdrawing, increasing or decreasing a thickness of at least a part of the underdrawing, changing a curvature of at least a part of the underdrawing, rotating the underdrawing, or symmetrically mirroring the underdrawing.

In response to the user input, the processor 190 of the user terminal 11 may be configured to receive first input information related to the drawn sketch 711. The received first input information may be, for example, a coordinate value related to a trace of the drawing, a speed of the drawing, a pressure of the drawing, a section of the drawing, a time of the drawing, an image of the drawn sketch, a changed underdrawing image, or the like.

As indicated by reference numeral 720 of FIG. 7A, the processor 190 may be configured to control the display unit 130 to display one or more images 721 and 722 found based on the drawn sketch 711 as the first search result.

For example, the processor 190 may be configured to control the display unit 130 to display the one or more found images 721 and 722 as a first search result in response to a user input of drawing the sketch 711 and selecting a search button (not shown) by the user. When an event is generated based on a predetermined cycle (for example, 5 seconds to 10 seconds) or based on a drawing change (for example, temporary stop of the drawing, stop of the drawing, or the like) while the user draws the sketch, the processor 190 may be configured to control the display unit 130 to automatically display the one or more found images 721 and 722 as the first search result. The cycle on which the first search result is automatically displayed may, for example, be configured by the user through a separately provided menu.

The processor 190 may be configured to transmit information related to the drawn sketch 711 to the server 21 through the communication unit 140 to acquire the first search result.

The information related to the drawn sketch 711 may be, for example, data generated by compressing the drawn sketch 711 in a particular format.

The server 21 may search for an image equal or similar to the received sketch 711 using information related to the received sketch 711. For example, the server 21 may search for an image having the outline that is the same as or similar to the received sketch 711. The server 21 may transmit the found image to the user terminal 11.

When the images searched for by the server 21 are acquired through the communication unit 140, the processor 190 may be configured to control the display unit 130 to display at least one of the acquired images. The processor 190 may be configured to acquire at least one image that is the same as or similar to the drawn sketch 711 from the memory 150. The processor 190 may be configured to acquire at least one image that is the same as or similar to the drawn sketch 711 from a user terminal 12 of a third party connected to the user terminal 11 for communication.

When the number of images found as the first search result is plural, the found images may be displayed in various forms such as a list form, a tile form, a slide form, a cover flow form, and the like. The images may be classified into similar images and arranged in divided areas or may be displayed to be divided by folders.

With respect to the image, only an outline may be displayed, the outline of the image may be highlighted, or the image and the outline may be separately displayed.

The found image may, for example, include an image which has a shape different from that of the sketched image but is the same type. For example, when it is determined that the sketch drawn in the server 21 or the user terminal 11 has a shoe shape, the server 21 may acquire one or more candidate images classified as the shoe from the database 431 and transmit the acquired candidate images to the user terminal 11. When the candidate images are acquired from the server 21 through the communication unit 140, the processor 190 may be configured to control the display unit 130 to display the candidate images.

The user input unit 180 may receive a user input of selecting one image 722 between the one or more images 721 and 722 displayed as the first search result.

According to another example, when the number of images displayed as the first search result is plural, the user input unit 180 may receive a user input of selecting a plurality of images.

In response to the user input, the processor 190 may be configured to control the display unit 130 to display the selected image 722 as indicated by reference numeral 730 of FIG. 7B.

According to another example, when the number of selected images is plural, the processor 190 may be configured to control the display unit 130 to display the plurality of selected images together. For example, the processor 190 may be configured to control the display unit 130 to display one image generated by combining the plurality of selected images. For example, the processor 190 may be configured to control the display unit 130 to display common features among the plurality of selected images. For example, when both a first image and a second image among the plurality of selected images include a first object (for example, a shoe or the like), the processor 190 may be configured to control the display unit 130 to display the first object. The processor 190 may be configured to control the display unit 130 to overlappingly display outlines of the plurality of selected images.

The user input unit 190 may receive a user input of selecting a part 722-1 of the image 722.

In response to the user input, the processor 190 may be configured to control the display unit 130 to display a menu 741 for selecting some attributes of the image 722 as indicated by reference numeral 740 of FIG. 7B. In the menu 741, at least one of the various types of attribute information related to materials, for example, a leather material, a foam material, a metal material, and the like, may be displayed as the attribute information which can be selected by the user. Next, the user input unit 190 may receive a user input of selecting one piece of attribute information 741-1 among the attribute information.

In response to the user input, the processor 190 may be configured to control the display unit 130 to display an edited image 751 by applying the selected attribute information 741-1 to the part 722-1 of the image as indicated by reference numeral 750 of FIG. 7C. For example, the processor 190 may be configured to control the display 130 to display the part of the image with the leather material. The application of the selected attribute information 741-1 to the edited image may include, for example, an overlay of a layer to which the selected attribute information 741-1 is applied on a layer including the image 722.

A process in which the user applies the attribute information to the part 722-1 of the image may be repeated several times. For example, in response to a user input of sequentially applying the same or different pieces of attribute information to parts of the image several times, the processor 190 may be configured to control the display unit 130 to display the edited image by applying the pieces of attribute information to the parts of the image.

As indicated by reference numeral 760 of FIG. 7C, the processor 190 may be configured to control the display unit 130 to display an image 761 additionally found based on the edited image 751 as the second search result. For example, the processor 190 may be configured to control the display unit 130 to display the additionally found image 761 as the second search result in response to a user input of editing the image and selecting a search button (not shown) by the user. The processor 190 may be configured to control the display unit 130 to automatically display the additionally found image 761 as the second search result without a user's additional input once the edited image 751 is displayed.

The processor 190 may be configured to transmit information related to the edited image 751 to the server 21 through the communication unit 140 to acquire the second search result.

The information related to the edited image 751 may be image data generated by compressing the edited image 751 in a particular format.

When the information related to the second search result remains in the server 21, the processor 190 may be configured to transmit attribute information applied to the edited image 751 to the server 21 through the communication unit 140.

The server 21 may search for an image equal or similar to the edited image in the database 431 by using at least one of the information related to the edited image 751 and the attribute information applied to the edited image 751. The server 21 may transmit the found image to the user terminal 11.

When the images searched for by the server 21 are acquired through the communication unit 140, the processor 190 may be configured to control the display unit 130 to display at least one of the acquired images. The processor 190 may be configured to acquire at least one image that is the same as or similar to the edited image 751 from the memory 150. The processor 190 may be configured to acquire at least one image that is the same as or similar to the edited image 751 from the user terminal 12 of a third party connected to the user terminal 11 for communication.

When the number of images found as the second search result is plural, the found images may, for example, be displayed in various forms such as a list form, a tile form, a slide form, and the like. The images may be classified into similar images and arranged in divided areas or may be displayed to be included in divided folders.

With respect to the image, only an outline may be displayed, the outline of the image may be highlighted, or the image and the outline may be separately displayed.

The found image may include an image which has a shape different from that of the sketched image but is of the same type.

As described above, by searching for the image through the drawn sketch and editing the found image by using attribute information, the user can quickly and accurately find an image to be searched for. When the user applies attribute information to at least a part of the image to edit the image, a process of displaying the image found based on the edited image may be repeated several times. For example, the user may repeatedly edit the image until the image which the user desires is found and continuously receive an image additionally found based on the edited image.

During a process of searching for the desired image, the user may extract an outline of the found image and perform an additional sketch based on the extracted outline. For example, a UI element to receive a user input of selecting the outline of the found image may be displayed, and the outline of the found image may be displayed in response to a user input of extracting the UI element.

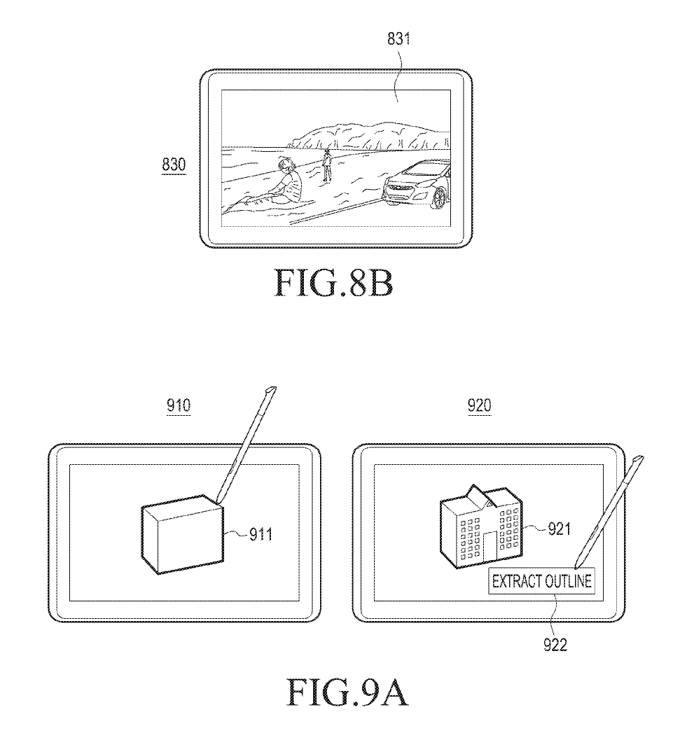

FIGS. 8A and 8B are diagrams illustrating an example process in which the user terminal 11 displays a found image.

Referring to reference numeral 810 of FIG. 8A, the user input unit 180 may receive a user input of drawing a sketch 811 on the display unit 130 by using a finger or an input tool. The user may draw the sketch on the image displayed on the display unit 130 as a foundation.

As indicated by reference numeral 820 of FIG. 8A, the processor 190 may be configured to control the display unit 130 to display attribute information for determining attributes of the sketch 811. The displayed attribute information may include icons related to temperature or weather, for example, warm, hot, dry, cool, cold, and the like.

The user input unit 180 may receive a user input of selecting one piece of attribute information 821 among the attribute information.

In response to the user input, the processor 190 may be configured to control the display unit 130 to display an image 831 found based on the drawn sketch 811 and the selected attribute information 821 as indicated by reference numeral 830 of FIG. 8B. For example, the processor 190 may be configured to control the display unit 130 to display the found image 831 in response to a user input of selecting a search button (not shown). The processor 190 may be configured to control the display unit 130 to automatically display the found image 831 in response to a user input of selecting the attribute information 821.

The processor 190 may be configured to transmit information related to the drawn sketch 811 and the selected attribute information 821 to the server 21 through the communication unit 140 to acquire the second search result. The server 21 may search for an image, which is the same as or similar to the received sketch 811 and to which the selected attribute information 821 is mapped, using the information related to the received sketch 811 and the selected attribute information 821. Further, the server 21 may transmit the found image to the user terminal 11.

When the image found by the server 21 is acquired through the communication unit 140, the processor 190 may be configured to control the display unit 130 to display the acquired image. The processor 190 may be configured to acquire the image that is the same as or similar to the drawn sketch from the memory 150. The processor 190 may be configured to acquire the image that is the same as to similar to the drawn sketch from the user terminal 12 of a third party connected to the user terminal 11 for communication.

As described above, by searching for the image through the drawn sketch and the attribute information related to the drawn sketch, the user can quickly and accurately find an image to be searched for. The process in which the user searches for the image may be repeated several times. For example, the user may additionally draw a sketch on a foundation or underdrawing, which is an image found based on the drawn sketch and the attribute information, or add new attribute information. The user may receive a desired image by repeating the process.

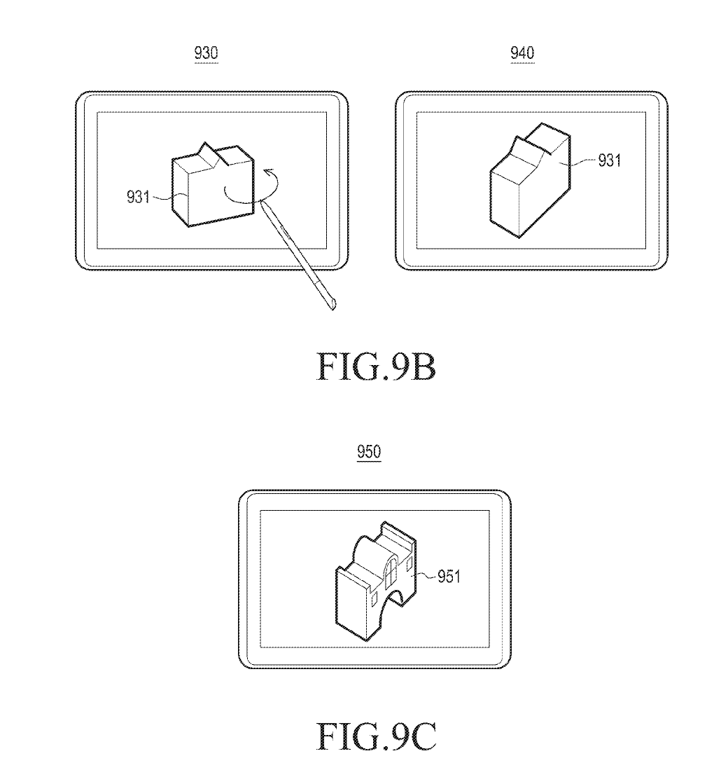

FIGS. 9A to 9C are diagrams illustrating an example process in which the user terminal 11 displays a found image.

Referring to reference numeral 910 of FIG. 9A, the user input unit 180 may receive a user input of drawing a sketch 911 of a three dimensional object on the display unit 130 by using a finger or an input tool.

In response to the user input, the processor 190 may be configured to control the display unit 130 to display a three dimensional image 921 found based on the drawn sketch of the three dimensional object as a first search result as indicated by reference numeral 920 of FIG. 9A. The three dimensional image may be an image having feature points mapped based on X, Y, and Z axes.

The user input unit 180 may receive a user input of extracting an outline of the found three dimensional image 921. The user input may be a user input of selecting an outline extraction UI element 922.

In response to the user input, the processor 190 may be configured to control the display unit 130 to display an outline 931 of the three dimensional image as indicated by reference numeral 930 of FIG. 9B.

The user input unit 180 may receive a user input converting the outline 931 of the three dimensional image.

In response to the user input, the processor 190 may be configured to control the display unit 130 to display the outline 931 of the three dimensional image while the three dimensional image is rotated as indicated by reference numeral 940 of FIG. 9B.

As indicated by reference numeral 950 of FIG. 9C, the processor 190 may be configured to control the display unit 130 to display an image 951 additionally found based on the converted outline 931 of the three dimensional image as a second search result. For example, the processor 190 may be configured to control the display unit 130 to display the additionally found image 951 as the second search result in response to a user input of selecting a search button (not shown) in a state where the outline 931 of the three dimensional image is displayed. The processor 190 may be configured to control the display unit 130 to automatically display the additionally found image as the second search result without a user's additional input once the outline of the three dimensional image is converted.

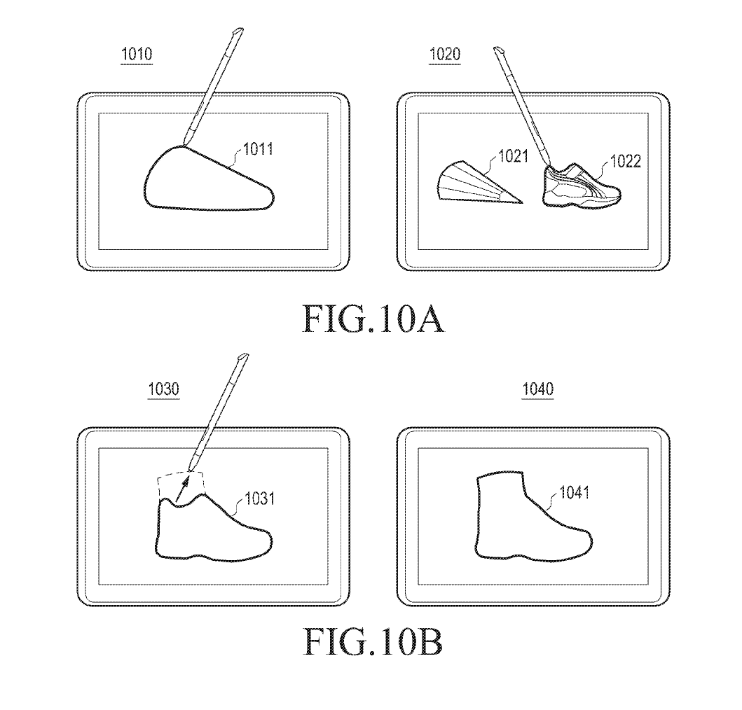

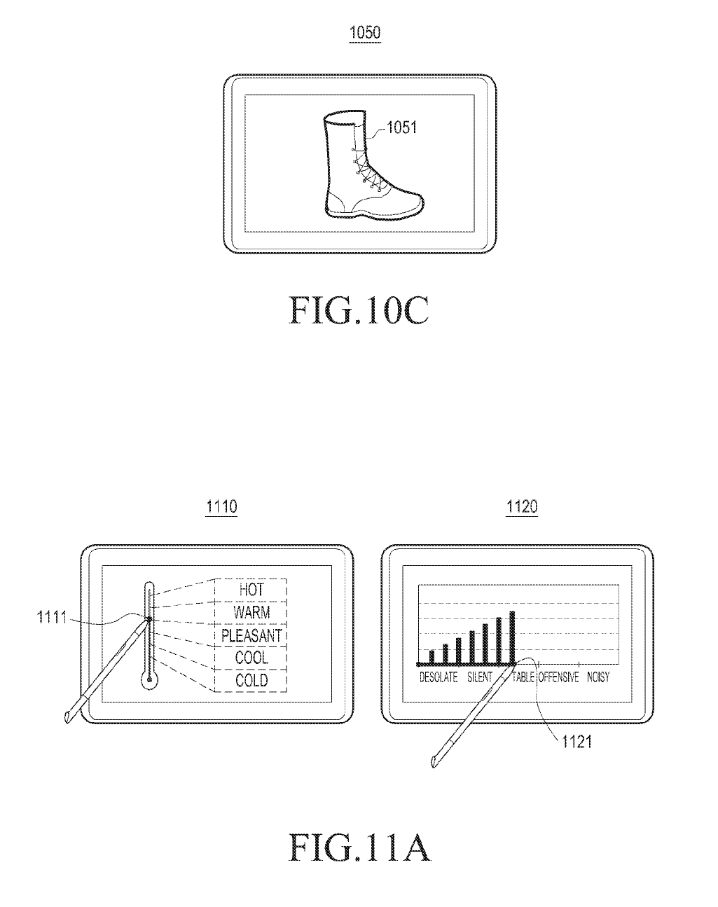

FIGS. 10A to 10C are diagrams illustrating an example process in which the user terminal 11 displays a found image.

Referring to reference numeral 1010 of FIG. 10A, the user input unit 180 may receive a user input of drawing a sketch 1011 on the display unit 130 by using a finger or an input tool.

In response to the user input, the processor 190 may be configured to control the display unit 130 to display one or more images 1021 and 1022 found based on the drawn sketch 1011 as a first search result as indicated by reference numeral 1020 of FIG. 10A. The user input unit 180 may receive a user input of selecting one image 1022 between the one or more images 1021 and 1022 displayed as the first search result.

In response to the user input, the processor 190 may be configured to control the display unit 130 to display an outline 1031 of the selected image as indicated by reference numeral 1030 of FIG. 10B. The user input unit 180 may receive a user input of changing the outline 1031 of the image displayed as the first search result.

In response to the user input, the processor 190 may be configured to control the display unit 130 to display the image 1041 having the changed outline as indicated by reference numeral 1040 of FIG. 10B.

Changing the outline of the image may include, for example, deleting at least a part of the outline, extending at least a part of the outline, adding another outline, increasing or decreasing the size of the outline, or changing a position of at least a part of the outline. Changing the outline of the image may include, for example, increasing or decreasing a thickness of the outline or changing a curvature of the outline. A method of changing the curvature of the outline may be performed by, for example, when a Non-Uniform Rational B-Spline (NURBS) curve is generated with respect to the outline selected by the user, replacing movement at a position selected by the user with movement of a control point of the NURBS curve.

As indicated by reference numeral 1050 of FIG. 10C, the processor 190 may be configured to control the display unit 130 to display an image 1051 additionally found based on the edited image as a second search result. For example, the processor 190 may be configured to control the display unit 130 to display the additionally found image 1051 as the second search result in response to a user input of editing the image and selecting a search button (not shown) by the user. The processor 190 may be configured control the display unit 130 to automatically display the additionally found image 1051 as the second search result without a user's additional input once the image is edited.

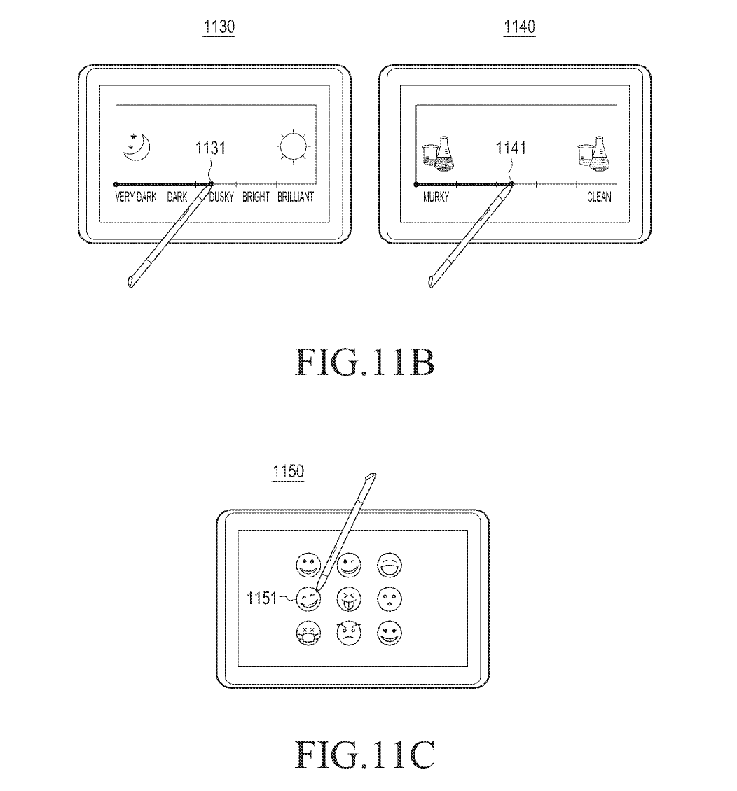

FIGS. 11A to 11C are drawings illustrating example attribute information related to at least a part of an image.

Referring to reference numeral 1110 of FIG. 11A, attribute information may, for example, be information related to temperature. The information related to temperature may be, for example, attribute information corresponding to hot, warm, pleasant, cool, cold, and a predetermined value between the attribute information. For example, the user may draw a sketch and select one piece of attribute information by touch-dragging a temperature control UI element 1111 of a thermometer icon up to a range corresponding to the one piece of attribute information.

Based on a user input of selecting attribute information, the processor 190 may be configured to control the display unit 130 to display an image found based on the selected attribute information related to temperature.

In another example, referring to reference numeral 1120 of FIG. 11A, the attribute information may, for example, be information related to volume. The information related to volume may be, for example, attribute information corresponding to desolate, silent, comfortable, offensive, noisy, and a predetermined value between the attribute information. For example, the user may draw a sketch and select one piece of attribute information by touch-dragging a volume control UI element 1121 up to a range corresponding to the one piece of attribute information.

Based on a user input of selecting attribute information, the processor 190 may be configured to control the display unit 130 to display an image found based on the selected attribute information related to volume.

In another example, referring to reference numeral 1130 of FIG. 11B, the attribute information may, for example, be information related to brightness. The information related to brightness may be, for example, attribute information corresponding to very dark, dark, dusky, bright, brilliant, and a predetermined value between the attribute information. For example, the user may draw a sketch and select one piece of attribute information by touch-dragging a brightness control UI element 1131 up to a range corresponding to the one piece of attribute information.

Based on a user input of selecting attribute information, the processor 190 may control the display unit 130 to display an image found based on the selected attribute information related to brightness.

In another example, referring to reference numeral 1140 of FIG. 11B, the attribute information may, for example, be information related to a pollution level. The information related to the pollution level may be, for example, attribute information corresponding to murky, clean, and a predetermined value between the attribute information. For example, the user may draw a sketch and select one piece of attribute information by touch-dragging a pollution level control UI element 1141 up to a range corresponding to the one piece of attribute information.

Based on a user input of selecting attribute information, the processor 190 may be configured to control the display unit 130 to display an image found based on the selected attribute information related to the pollution level.

In another example, referring to reference numeral 1150 of FIG. 11C, the attribute information may, for example, be information related to an emotion. The attribute information related to the emotion may be, for example, attribute information related to joy, pleasure, anger, disappointed, and the like. For example, the user may draw a sketch and select an icon 1151 corresponding to one piece of the attribute information.

Based on a user input of selecting attribute information, the processor 190 may be configured to control the display unit 130 to display an image found based on the attribute information related to the selected icon.

In addition, the attribute information may further include, for example, scent information, color information, material information, texture information, weather information, temperature information, sound information, and atmosphere information, but is not limited thereto.

The attribute information may be applied to an entirety or a part of the sketch drawn by the user or the found image. A plurality of pieces of attribute information may be applied together to an entirety or a part of the drawn sketch or the found image. The plurality of attribute information may be different types of attribute information. For example, emotional information and material information may be applied together to a part of the drawn sketch.

The user may determine attribute information by directly inputting a text-based keyword. When a plurality of pieces of attribute information are provided in the form of palette or templates, the user may select one of the plurality of pieces of attribute information.

As described above, when pieces of attribute information related to the drawn sketch or the found image are used together, the user may find a desired image more quickly.

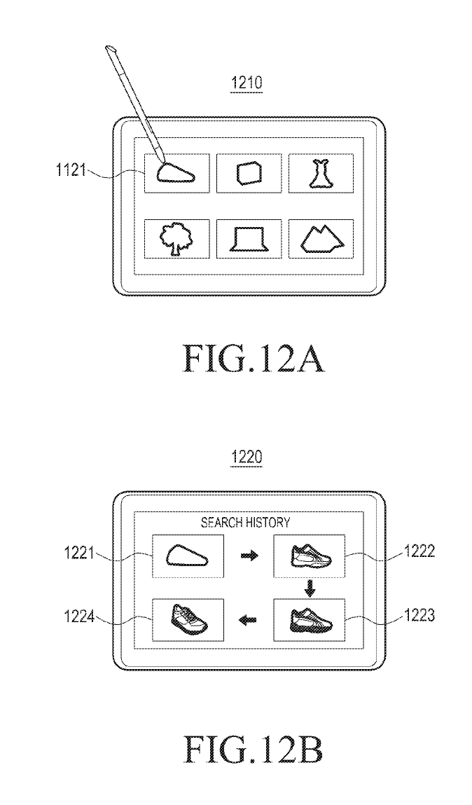

FIGS. 12A and 12B are diagrams illustrating example drawn sketches.

Referring to FIG. 12A, the processor 190 may be configured to control the display unit 130 to display sketches drawn by the user. For example, in response to a user input of selecting a UI element that provides a sketch history, the processor 190 may be configured to control the display unit 130 to display the sketches drawn by the user. The drawn sketches may be displayed in various forms such as, for example, a list form, a tile form, a slide form, a cover flow form, and the like, but are not limited thereto.

The drawn sketches may be arranged according to, for example, a drawn time order, a name order of the image found using the drawn sketch, a bookmark order, or the like.

The user input unit 180 may receive a user input of selecting one sketch 1121 among the drawn sketches.

Referring to FIG. 12B, in response to the user input, the processor 190 may be configured to control the display unit 130 to display a search history generated by searching for the image related to the selected sketch. For example, in the search history, a first sketch 1121 drawn by the user, a first image 1222 found as a first search result based on the drawn sketch, a first image 1223 edited by the user, and a second image 1224 found as a second search result based on the edited image may be displayed.

For example, the user may select one of the first sketch 1121, the first image 1222, the edited first image 1223, and the second image 1224 and draw a sketch by using the selected sketch or image as a foundation or an underdrawing or search for an image related to the selected sketch or image.

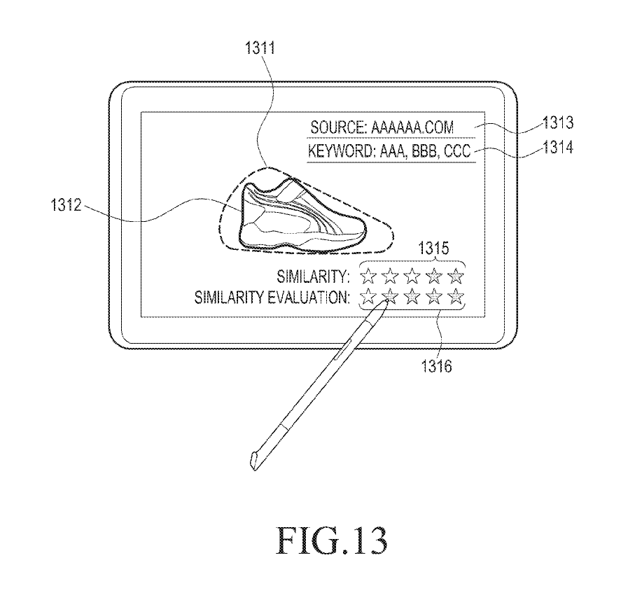

FIG. 13 is a diagram illustrating an example found image.

Referring to FIG. 13, the processor 190 may be configured to control the display unit 130 to display at least one of a drawn sketch 1311 and an image 1312 found based on the drawn sketch.

The processor 190 may be configured to control the display unit 130 to display a source 1313 of the found image and at least one of keywords 1314 that represent the image. For example, the user may identify whether the found image is the image for which the user desires to search based on the source 1313 of the image or the keywords 1314, and additionally search for another image by using the source 1313 of the image or the keywords 1314.

The processor 190 may be configured to control the display unit 130 to display graphics 1315 indicating a level of similarity between the drawn sketch and the found image.

For example, when the similarity between the drawn sketch and the found image is determined using the aforementioned similarity algorithm, the processor 190 may be configured to control the display unit 130 to display a larger number of highlighted stars in the graphics 1315 as the similarity is higher, and to control the display unit 130 to display a smaller number of highlighted stars in the graphics 1315 as the similarity is lower.

The processor 190 may be configured to control the display unit 130 to display a similarity evaluation UI element 1316, through which the user can directly evaluate the similarity between the drawn sketch and the found image. For example, when the user selects the similarity between the drawn sketch and the found image through the similarity evaluation UI element 1316, a selection result may be transmitted to the server 21 and used later when the user or another user searches for an image equal or similar to the drawn sketch.

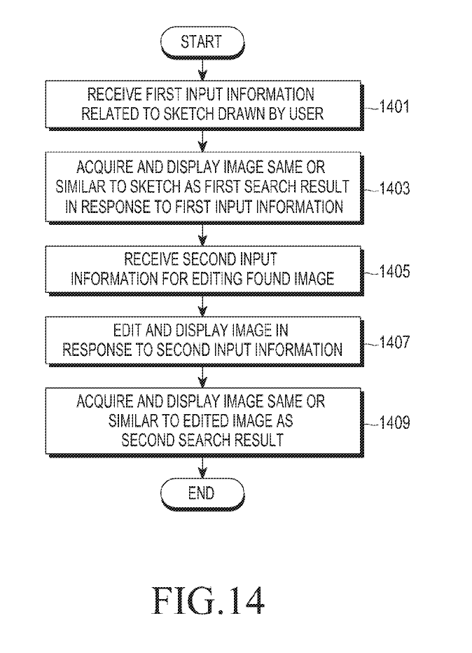

FIG. 14 is a flowchart illustrating an example method of displaying an image in the user terminal 11.

Referring to FIG. 14, the user terminal 11 may receive first input information related to a sketch drawn by the user in step 1401.

In response to the received first input information, the user terminal 11 may acquire and display an image the same as or similar to the sketch as a first search result in step 1403. The user terminal 11 may highlight and display an outline of the image equal or similar to the sketch. Highlighting and displaying the outline of the image may include making a color of a surface of the image transparent or the same as a background color to make only the outline of the image shown.

The user terminal 11 may receive second input information for editing the found image as the first search result in step 1405.

The user terminal 11 may edit and display the image in response to the received second input information in step 1407. For example, the user terminal 11 may apply attribute information to at least a part of the found image and display the image to which the attribute information is applied. The attribute information may, for example, be at least one of, for example, emotional information, scent information, weather information, temperature information, material information, color information, touch information, sound information, and atmosphere information. The user terminal 11 may change at least a part of the outline of the found image and display the image having the changed outline.

The user terminal 11 may acquire and display an image equal or similar to the edited image as a second search result in step 1409.

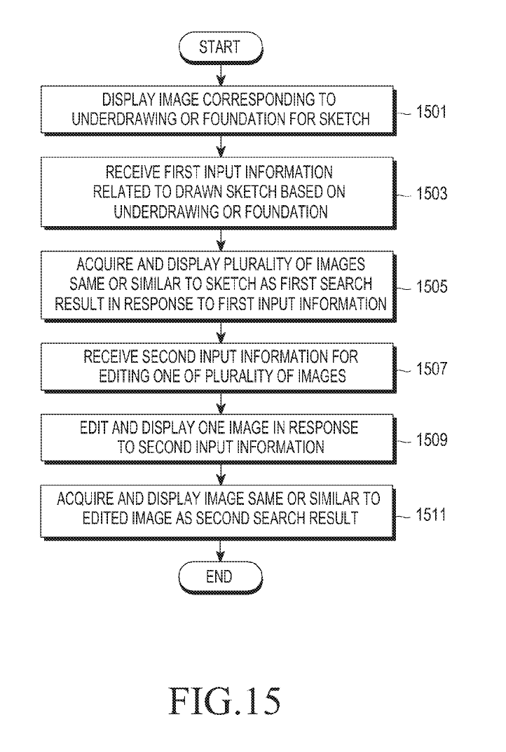

FIG. 15 is a flowchart illustrating an example method of displaying an image in the user terminal 11.

Referring to FIG. 15, the user terminal 11 may display an image used as an underdrawing or a foundation of the sketch in step 1501.

The user terminal 11 may receive first input information related to the drawn sketch based on the displayed underdrawing or foundation in step 1503.

In response to the received first input information, the user terminal 11 may acquire and display a plurality of images the same as or similar to the sketch as a first search result in step 1505. For example, the user terminal 11 may transmit information related to the sketch to the server 21, acquire the plurality of images equal or similar to the sketch from the server 21 as the first search result, and display the acquired images.

The user terminal 11 may receive second input information for editing one of the plurality of images in step 1507. For example, the user terminal 11 may select one of the plurality of images and receive second input information of the user for editing the one selected image.

The user terminal 11 may edit and display the one selected image in response to the received second input information in step 1509.

The user terminal 11 may acquire and display an image the same as or similar to the edited image as a second search result in step 1511.

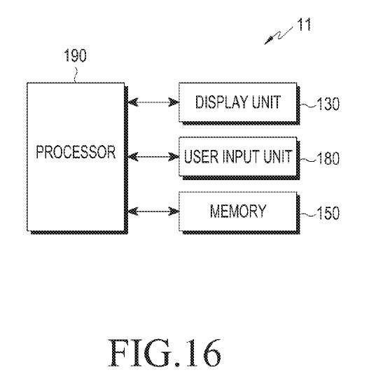

FIG. 16 is a block diagram illustrating an example configuration of the user terminal 11.

Referring to FIG. 16, the user terminal 11 may include the processor 190, the display unit 130, the user input unit 180, and the memory 150. Since the example of each component of the user terminal 11 has been described above, an overlapping description thereof will be omitted.

In FIG. 16, the processor 190 may be configured to acquire an image the same as or similar to a sketch drawn by the user as a first search result from the server 21 in response to first input information received through the user input unit 180. The processor 190 may be configured to control the display unit 130 to display the image corresponding to the first search result.

The processor 190 may be configured to control the display unit 130 to display an image generated by editing the image corresponding to the first search result, in response to second input information received through the user input unit 180 in a state where the image corresponding to the first search result is displayed.

The processor 190 may be configured to acquire an image the same as or similar to the edited image as a second search result from the server 21. The processor 190 may be configured to control the display unit 130 to display the image corresponding to the second search result.

An apparatus (for example, the user terminal 11 or the server 21) or a method (for example, operations) according to various examples may be performed by, for example, at least one computer (for example, the processor 190 or the processor 410) that executes instructions included in at least one of programs maintained in a computer-readable storage medium.

When the instructions are executed by the computer (for example, processor 190 or the processor 410), the at least one computer may perform a function corresponding to the instructions. The computer-readable storage medium may be, for example, the memory 150 or the memory 430.

The program may be included in the computer readable storage medium such as a hard disk, a floppy disk, magnetic media (for example, a magnetic tape), optical media (for example, a Compact Disc Read Only Memory (CD-ROM) and a Digital Versatile Disc (DVD)), magneto-optical media (for example, a floptical disk), a hardware device (for example, a Read Only Memory (ROM), a Random Access Memory (RAM), a flash memory), and the like. For example, the storage medium may be generally included as a part of the configuration of the user terminal 11 or the server 21, installed through a port of the user terminal 11 or the server 21, or included in an external device (for example, cloud, server, or another electronic device) located outside the user terminal 11 or the server 21. Further, the programs may be divisibly stored in a plurality of storage media and, at this time, at least some of the plurality of storage media may be located in an external device outside the user terminal 11 or the server 21.

In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Although example embodiments of the disclosure have been illustrated and described, it should be appreciated that the disclosure is not limited thereto. It will be apparent that various modifications and changes may be made by those skilled in the art without departing from the scope of the disclosure as defined by the appended claims, and these modifications and changes should not be construed separately from the technical idea or view of the disclosure.

What is claimed is:

1. A method of displaying an image by a user terminal, comprising:
receiving first input information based on a sketch drawn by a user on the user terminal;
acquiring and displaying an image the same as or similar to the sketch as a first search result in response to the first input information ;
receiving second input information for editing the acquired image based on the first search result;
editing and displaying the acquired image in response to the second input information on the user terminal; and
acquiring and displaying an image the same as or similar to the edited image as a second search result.

2. The method of claim 1, wherein the editing and displaying of the acquired image comprises: applying attribute information to at least a part of the acquired image and displaying the edited acquired image on the user terminal.

3. The method of claim 1, wherein the editing and displaying of the acquired image comprises: changing at least a part of an outline of the acquired image and displaying the changed acquired image on the user terminal.

4. The method of claim 1, wherein the displaying of the image the same as or similar to the sketch comprises: highlighting an outline of the image the same as or similar to the sketch and displaying the highlighted image on the user terminal.

5. The method of claim 1, further comprising, before the receiving of the first input information, displaying an image capable of being an underdrawing or a foundation of the sketch on the user terminal.

6. The method of claim 1, further comprising, when the displayed image includes a plurality of images as the first search result, receiving third input information for selecting at least one image to be edited, from the plurality of images.

7. The method of claim 1, wherein the attribute information comprises at least one of: emotional information, scent information, material information, color information, touch information, sound information, weather information, temperature information, and atmosphere information.

8. The method of claim 1, wherein the acquiring and displaying of the image the same as or similar to the edited image as the second search result comprises: acquiring the image the same as or similar to the edited image from an external server in communication with the user terminal and displaying the acquired image as the second search result on the user terminal.

9. A method of providing an image by a server, comprising:
acquiring information related to a sketch from a user terminal;
acquiring an image the same as or similar to the sketch as a first search result based on the information related to the sketch;
transmitting the image corresponding to the first search result to the user terminal;
acquiring edited information of the image from the user terminal;
acquiring an image the same as or similar to the edited image as a second search result based on the edited information; and
transmitting the image corresponding to the second search result to the user terminal.

10. The method of claim 9, wherein the acquiring of the edited information of the image comprises acquiring attribute information related to the image.

11. A user terminal for displaying an image, the user terminal comprising:
input circuitry configured to receive a user input;
a display configured to display an image;
a memory configured to store one or more programs; and
a processor configured to execute instructions included in the one or more programs of the memory, to acquire, in response to first input information related to a sketch received through the input circuitry, an image the same as or similar to the sketch as a first search result and to display the acquired image on the display, to edit the acquired image based on the first search result in response to second input information for editing the acquired image and to display the edited image on the display, and to acquire and display an image the same as or similar to the edited image as a second search result.

12. The user terminal of claim 11, wherein, when the acquired image is edited and displayed on the display, the processor is configured to execute instructions to apply attribute information to at least a part of the acquired image and to display the image to which the attribute information is applied.

13. The user terminal of claim 11, wherein, when the acquired image is edited and displayed on the display unit, the processor is configured to execute instructions to change at least a part of an outline of the acquired image and to display the changed acquired image.

14. The user terminal of claim 11, wherein, when the image the same as or similar to the sketch is displayed on the display, the processor is configured to execute instructions to highlight an outline of the image the same as or similar to the sketch and to display the highlighted image.

15. The user terminal of claim 11, wherein the processor is configured to execute instructions to display an image used as an underdrawing or a foundation of the sketch.

16. The user terminal of claim 11, wherein the attribute information comprises at least one of: emotional information, scent information, material information, color information, touch information, sound information, weather information, temperature information, and atmosphere information.

17. The user terminal of claim 11, wherein, when the image the same as or similar to the edited image is acquired as the second search result and displayed on the display, the processor is configured to execute instructions to acquire the image the same as or similar to the edited image from an external server in communication with the user terminal and to display the acquired image as the second search result.

18. A server for providing an image, the server comprising:
communication circuitry configured to communicate with a user terminal;
a memory configured to store one or more programs; and
a processor configured to execute instructions stored in the one or more programs of the memory, to acquire, based on information related to a sketch acquired from the user terminal through the communication circuitry, an image the same as or similar to the sketch as a first search result and to transmit the acquired image to the user terminal, to acquire, based on edtied information of the image acquired from the user terminal, an image the same as or similar to the edited image as a second search result and to transmit the acquired edited image to the user terminal.

19. The server of claim 18, wherein the processor is configured to execute instructions to transmit the image the same as or similar to the edited image to the user terminal based on attribute information related to the image acquired from the user terminal.
